(19) United States
(12) Patent Application Publication
(10) Pub. No.: US 2025/0131615 A1
(43) Pub. Date: Apr. 24, 2025

(54) SYSTEMS AND METHODS FOR ACCELERATING SPECT IMAGING

(71) Applicant: Subtle Medical, Inc., Menlo Park, CA (US)

(72) Inventor: Ludovic Sibille, Rosny-sur-Seine (FR)

(21) Appl. No.: 19/001,901

(22) Filed: Dec. 26, 2024

Related U.S. Application Data
(63) Continuation of application No. PCT/US2023/069144, filed on Jun. 27, 2023.
(60) Provisional application No. 63/368,952, filed on Jul. 20, 2022.
(60) Provisional application No. 63/358,305, filed on Jul. 5, 2022.

(51) Int. Cl. G06T 11/00; G06T 5/50; G06T 5/60

(52) U.S. Cl. CPC G06T 11/006; G06T 5/50; G06T 5/60; G06T 11/008; G06T 2207/10108; G06T 2207/20081; G06T 2207/20084; G06T 2211/441

(57) ABSTRACT

A computer-implemented method is provided for improving image quality. The method comprises: (a) acquiring, using single-photon emission computed tomography (SPECT), a first medical image of a subject, the first medical image is acquired with an acceleration scheme; (b) combining the medical image with a second medical image acquired using computed tomography (CT) to generate an input image; and selecting a deep learning network model to apply to the input image based at least in part on the acceleration scheme and outputting an enhanced medical image.

### CROSS-REFERENCE TO RELATED APPLICATION

This application is a continuation of International Application No. PCT/US2023/069144, filed Jun. 27, 2023, which claims priority to U.S. Provisional Application No. 63/358,305 filed on Jul. 5, 2022, and U.S. Provisional Application No. 63/368,952 filed on Jul. 20, 2022, the content of which is incorporated herein in its entirety.

### BACKGROUND

Single-photon emission computed tomography (SPECT) is a nuclear medicine tomographic imaging technique using gamma rays. A SPECT scan monitors level of biological activity at each place in a 3-D region analyzed. Similar to conventional nuclear medicine planar imaging using a gamma camera, before a scan, a radioactive tracer (e.g., gamma-emitting radioisotope (a radionuclide)) is injected into the patient, the emissions from the radionuclide indicate is then captured by a gamma camera of the SPECT system.

However, standard acquisition time for one SPECT image can be long (e.g., about 20 min/bed) which is uncomfortable and intolerable for patients to hold still in the scanner. For example, the SPECT acquisition and processing parameters for a dual-head γ-camera may include a 180° detector head orientation, a 360° circular orbit, 60-64 stops, a 128×128 matrix, and 10-40 s/stop. Undesirable imaging artifacts as well as misplacement of events in space may appear due to the long scan time and the undesired movement of patient during the scan. The lengthy exam time may also make the procedure uncomfortable for patients who have difficulty staying still. Such long scan time for SPECT exams may result in high imaging cost and limit the patient volume and accessibility. Additionally, reducing the acquisition time may amplify noise and inevitably degrade the image quality, thus hampering clinical interpretation of SPECT images.

### SUMMARY

Current solutions may tackle the above-mentioned problems by improving the imaging device performance (e.g., improving detectors and or efficiency of the gamma camera), injection of a higher radiopharmaceutical dose or utilizing different reconstruction algorithms (e.g., OSEM, Flash-3D, BoneQuant). However, such solutions require extra cost in hardware or increase risk of exposure to radiopharmaceutical dose. A need exists for an improved acceleration method that does not require extra cost on imaging device or increasing the radiopharmaceutical dose. A further need exists for shortening the acquisition time of SPECT to improve patient's experience, reduce examination costs, and reduce the likelihood of patient motion during scanning without compromising the quality of SPECT images. The present disclosure provides improved single-photon emission computed tomography (SPECT) systems and methods that can address various drawbacks of conventional systems and methods, including those recognized above. Methods and systems of the presenting disclosure capable of providing improved image quality or preserving image quality with shortened image acquisition time. In particular, method and system of the presenting disclosure provide SPECT imaging with shortened image acquisition time without compromising image quality, requiring change of the hardware or reconstruction algorithm or increasing radiopharmaceutical dose.

Single-photon emission computed tomography (SPECT) can be combined with imaging modalities. For example, SPECT coupled with computed tomography (SPECT/CT) is an important and accurate diagnostic measurement. For instance, SPECT/CT techniques may provide accurate information for distinguishing prostate cancer bone metastases from spinal and pelvic osteoarthritic lesions. In another example, bone scintigraphy is a sensitive diagnostic test for detection of both benign and malignant osseous abnormalities. Bone scintigraphy uses a radiotracer to evaluate the distribution of active bone formation in the skeleton related to malignant and benign diseases. Radionuclide bone scans can detect altered metabolic activity much earlier than structural changes appear on anatomic radiographs or cross-sectional imaging such as CT and MRI. Following radiopharmaceutical injection, the tracer accumulation is dependent upon both blood flow and osteoblastic activity. An area of increased tracer uptake on bone scans may indicate increased vascularity and bone remodeling benign or malignant bone conditions. Depending on the imaging protocol, a patient may be injected with a radiopharmaceutical (e.g., 99mTc) and delayed images are usually obtained from 2 to 4 hours after injection of the tracer to allow it to clear from the soft tissues. In some cases, a whole body bone scintigraphy (anterior and posterior images) may be acquired along with additional SPECT images. The additional SPECT beneficially provides increased contrast and diagnostic sensitivity and specificity. Currently, targeted SPECT (e.g., focused on equivocal findings) combined with scintigraphy may be preferred over whole body SPECT scan due to the lengthy acquisition time of the whole body SPECT (e.g., 15 min for scintigraphy and 5 min/equivocal finding compared to 30 min for whole body SPECT).

Traditionally, shortened scan duration may result in low image quality. Methods and systems herein beneficially reduce the SPECT acquisition time thereby improving patient's experience, decreasing examination costs and motion artifacts. The SPECT/CT imaging may also be improved by the presented methods and systems by shortening the acquisition time without degrading the image quality. The provided methods and systems may significantly reduce SPECT scan time by applying deep learning techniques so as to mitigate imaging artifacts and improve image quality. Examples of artifacts in medical imaging may include noise (e.g., low signal noise ratio), blur (e.g., motion artifact), shading (e.g., blockage or interference with sensing), missing information (e.g., missing pixels or voxels in painting due to removal of information or reduction of projections), and/or reconstruction (e.g., degradation in the measurement domain).

The present disclosure provides an acceleration method employing deep learning techniques to improve the image quality acquired with shortened acquisition time (i.e., fast scan). In some cases, the deep learning techniques may comprise using a convolutional neural network (CNN)-based framework to generate SPECT images from a fast scan with image quality comparable to SPECT images acquired with standard acquisition time (e.g., slow scan) or long acquisition time. This beneficially accelerates SPECT image acquisition by an acceleration factor of at least 1.5, 2, 3, 4, 5, 6, 7, 8, 9, 10, 15, 20, a factor of a value above 20 or below 1.5, or a value between any of the two aforementioned values. For example, the fast scan SPECT images can be acquired with only 1/7 acquisition time (i.e., acceleration factor of 7) or faster without compromising the image quality. As utilized herein, the term “acceleration factor” (or reduction factor) may refer to the ratio between a standard acquisition time and accelerated acquisition time.

In some embodiments, an acceleration scheme may comprise reduction of the acquisition time per acquisition plane (e.g., standard 10-40 s per acquisition plane), a reduction of the number of acquisition planes or projections (e.g., standard 120 planes are acquired) or a combination of both. In some cases, upon selection of an acceleration factor (e.g., acceleration factor of 20) or a target acquisition time, the methods and systems herein may automatically determine an acceleration scheme for achieving the acceleration factor or the target acquisition time. In some embodiments, upon determining an acceleration scheme (e.g., reduction factor for acquisition time per acquisition plane, a reduction factor for reduction of the number of acquisition plane, etc.), systems and methods herein may automatically select models that adapt to the determined acceleration scheme and process images with the selected model to improve the image quality.

In some embodiments, the provided method may utilize the associated features between a fast SPECT scan and a corresponding CT image to improve anatomy structural boundary and overall image quality. Including CT image as the input of network beneficially provides a clear anatomy features resulting in clear boundary in the synthesized standard SPECT image. The term “standard SPECT image” as utilized herein generally refers to SPECT image acquired with standard acquisition time.

Additionally, the provided method may allow for faster SPECT imaging acquisition while preserving quantification accuracy related to physiological or biochemical information. For example, methods and systems of the present disclosure may provide accelerated SPECT image acquisition while preserving accuracy in standardized uptake quantification. The quantification accuracy may be preserved or improved over the fast scan SPECT image by boosting the image contrast and the accuracy (e.g., standardized uptake value (SUV) in lesion regions). The method herein may boost the image contrast and the accuracy (e.g., standardized uptake value (SUV) in lesion regions by penalizing the losses in these regions such as utilizing corresponding attention map.

The SPECT image acquisition can be accelerated by an acceleration factor of at least 1.5, 2, 3, 4, 5, 6, 7, 8, 9, 10, 15, 20, a factor of a value above 20 or below 1.5, or a value between any of the two aforementioned values. The term “fast scan SPECT image” may generally refer to a SPECT image acquired under shortened acquisition time at an acceleration factor of a value greater than 1. The standard acquisition time is at least 1, 2, 3, 4, 5, 6, 7, 8, 9, 10, 15, 20 times of the shortened acquisition time of the fast scan SPECT image.

In an aspect of the present disclosure, a computer-implemented method is provided for improving image quality. The method comprises: receiving a first medical image of a subject, where the first medical image is acquired with an acceleration scheme using single-photon emission computed tomography (SPECT); combining the medical image with a second medical image acquired using computed tomography (CT) to generate an input image; and applying a deep learning network model to the input image and outputting an enhanced medical image, the deep learning network model is selected based at least in part on the acceleration scheme.

In a related yet separate aspect, a non-transitory computer-readable storage medium including instructions that, when executed by one or more processors, cause the one or more processors to perform operations is provided. The operations comprise: receiving a first medical image of a subject, where the first medical image is acquired with an acceleration scheme using single-photon emission computed tomography (SPECT); combining the medical image with a second medical image acquired using computed tomography (CT) to generate an input image; and applying a deep learning network model to the input image and outputting an enhanced medical image, the deep learning network model is selected based at least in part on the acceleration scheme.

In some embodiments, the enhanced medical image has an image quality same as a SPECT image acquired with an acquisition time longer than the acquisition time of the acceleration scheme or has an image quality improved over the first medical image.

In some embodiments, the acceleration scheme comprises at least a first parameter indicating a shortened acquisition time per acquisition plane or a second parameter indicating a reduction of the number of acquisition plane. In some embodiments, the acceleration scheme comprises a first parameter indicating a shortened acquisition time per acquisition plane, and wherein the deep learning network model is trained using training dataset comprising a SPECT image acquired with shortened acquisition time per acquisition plane, a corresponding CT image and a SPECT image acquired using a standard acquisition time acquisition plane. In some cases, the input image to the deep learning network model comprises a plurality of image slices and wherein the deep learning network model comprises a 2D convolutional layer. In some cases, the deep learning network model is trained using a loss function to enhance an accuracy in a region of interest. In some cases, the deep learning network model is trained using an attention mask.

In some embodiments, the acceleration scheme comprises a second parameter indicative of a reduction of the number of acquisition planes, and wherein the deep learning network model is trained using training dataset comprising a SPECT image acquired with a reduction of acquisition planes, a corresponding CT image and a SPECT image acquired using a standard number of acquisition planes. In some cases, the input image to the deep learning network model comprises co-registered 3D volume of the first medical image and the second medical image. In some instances, the deep learning network model comprises a 3D convolutional layer.

In some embodiments, the deep learning network model is selected from a plurality of trained models, and wherein the plurality of trained models correspond to different types of artifacts or different acceleration schemes. In some embodiments, the first medical image is processed by a convolutional neural network (CNN) to synthesize one or more projection planes prior to operation (c).

In some embodiments, the first medical image and the second medical image are acquired simultaneously. In some cases, the second medical image is acquired without acceleration.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and descriptions are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 schematically shows an example of using a fast scan SPECT image and CT image as input of a deep learning model to synthesize a standard SPECT image.

FIG. 2 shows an example of a deep learning framework to synthesize SPECT image from fast SPECT image and the corresponding CT image.

FIG. 3 shows another example of a deep learning framework to synthesize SPECT image from fast SPECT image and the corresponding CT image.

FIG. 4 shows examples of artifacts in fast SPECT acquired at an acceleration factor of 4.

FIG. 5 shows an example of a method for processing the raw acquisition data prior to reconstruction.

FIG. 6 illustrates projection or acquisition planes and an exemplary method of representing position of a target projection or acquisition plane.

FIG. 7 schematically illustrates an example of a system comprising a computer system and one or more databases operably coupled to an imaging system over the network.

FIG. 8 shows examples of determining an acquisition scheme via the aforementioned.

FIGS. 9-15 show experiments and results of implementing the methods and models as described herein.

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Short scan duration or accelerated acquisition may result in low image quality. The image quality of the SPECT image as described herein may include general image quality (e.g., signal noise ratio, resolution, etc.), detail of radiotracer (e.g., 99mTc-MPD) distribution, presence of artifacts and/or general diagnostic confidence. SPECT imaging can be combined with other imaging modalities to provide imaging in different applications. For example, single-photon emission computed tomography coupled with computed tomography (SPECT/CT) plays a pivotal role for differential diagnosis such as for diagnosis of benign and malignant bone lesions. In the SPECT/CT hybrid imaging, images from the two different types of scans are combined together. For instance, a SPECT gamma scanner may be built to operate with a conventional CT scanner, with co-registration of images.

The combined SPECT/CT scan can provide precise information about how different parts of the body are working and more clearly identify problems. For example, reconstruction algorithms have been developed in bone hybrid imaging (SPECT/CT) scanner. Interactive reconstruction algorithms such as ordered subset expectation maximization (OSEM; Flash 3D; F3D) reconstruction algorithm, or an ordered subset conjugate gradient minimization algorithm (OSCGM; improving multimodal alignment in image space) may be utilized for image reconstruction. Such construction algorithms may provide SPECT images with bone anatomy appearance as a CT-based tissue segmentation is incorporated into SPECT reconstruction and also provide a quantitative reconstruction. Such progress of image acquisition and reconstruction could convey a higher diagnostic confidence through an enhanced bone uptake location. However, patient is still exposed to additional radiation exposure in terms of effective dose incurred in the CT portion of SPECT/CT examinations.

Although recent advances in hardware (e.g., cameras and collimators) and software (e.g., reconstruction algorithms incorporating noise regularization and resolution recovery) may facilitate reducing scanning time and/or injected contrast agent dose. Shortening the acquisition time may still degrade the image quality.

Methods and systems herein may effectively reduce the radiation exposure by shortening the SPECT/CT examination time (e.g., shorten the SPECT scan time) without compromising the quality of the output image. In some embodiments, systems and methods herein may synthesize an enhanced medical image from the fast scan SPECT image and CT image and the enhanced medical image may have an image quality same as a SPECT image acquired with standard acquisition time combined with a corresponding CT image. In some embodiments, the enhanced medical image may have an image quality improved over the fast scan SPECT image in terms of quantification accuracy. For example, the provided method may utilize the associated features between a fast SPECT scan and corresponding CT image to improve anatomy structural boundary and the overall image quality.

In some embodiments, the provided method may allow for faster SPECT imaging acquisition while preserving quantification accuracy related to physiological or biochemical information. For example, methods and systems of the present disclosure may provide accelerated SPECT image acquisition while preserving accuracy in standardized uptake quantification. The method herein may preserve or improve the quantification accuracy by boosting the image contrast and the accuracy (e.g., standardized uptake value (SUV) in lesion regions. In some cases, the image contrast and accuracy in lesion regions may be preserved by penalizing the losses in these regions such as utilizing an attention map. The attention map may comprise an attention feature map or region-of-interest (ROI) attention masks. The attention map may comprise information about the ROI (e.g., lesion attention map) or other attention map that comprises clinically meaningful information. For example, the attention map may comprise information about regions where particular tissues/features are located. For example, the proposed method can effectively suppress the noise texture in the fast-scanned SPECT image and recover clear anatomy structural details, especially SUV value in the lesion regions, which is comparable to SPECT image quality using standard acquisition time.

### Deep Learning Framework

The deep learning framework of the present disclosure may combine rich features from both a fast SPECT image and its corresponding CT image to predict a synthetized SPECT image with improved quality. In some embodiments, the provided method may incorporate an attention loss function to enhance sensitivity of the deep learning model to reconstruct ROI (e.g., lesion regions) with more accurate SUV measures.

The method herein may also be capable of quantitatively evaluating the image quality and performance of the model. For example, quantitative image quality metrics such as normalized root-mean-squared-error (NRMSE), peak signal to noise ratio (PSNR), and structural similarity (SSIM) may be calculated for the enhanced and non-enhanced accelerated SPECT scans, where higher image quality is represented by higher PSNR and/or SSIM. Other suitable image quality quantification metrics may also be utilized to quantify the image quality.

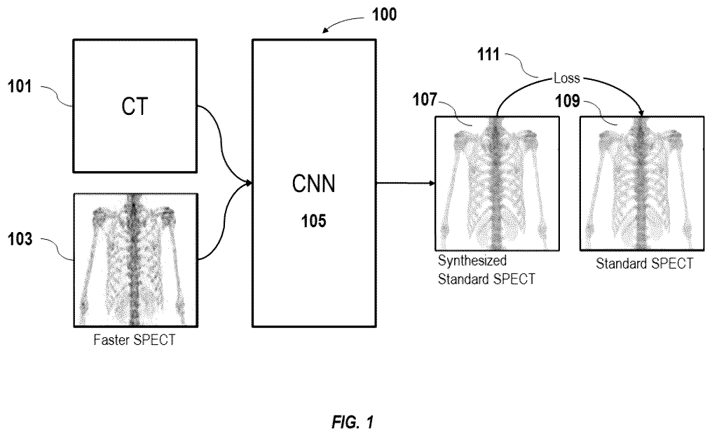

FIG. 1 schematically shows an example 100 of using a fast scan SPECT image 103 and CT image 101 as input of a deep learning model 105 to synthesize a standard SPECT image 107. In the example, the fast scan SPECT images 103 and corresponding CT image 101 are acquired by a SPECT/CT. The loss function 111 may be used as a critic of the synthesized SPECT image 107 against the ground truth standard SPECT image 109 to guide the optimization of the parameters of the deep learning model during model training. Details about the learning algorithm and loss function are described later herein.

The fast SPECT image 103 may be acquired with an acquisition time at a selected accelerator factor. For example, the image acquisition time of the fast SPECT image 103 may be ½, ⅓, ¼, ⅕, ⅙, 1/7, ⅛, 1/9 of the standard acquisition time. For example, the fast scan SPECT image 103 may be acquired with ⅛ standard acquisition time or faster. Compared to the standard SPECT 107 (SPECT acquired with standard time such as about 20 min/bed), the fast SPECT image 103 may have a degraded image quality (e.g., greater noise and artifacts, less detail of the radiotracer distribution).

The provided methods and systems may significantly reduce SPECT scan/acquisition time by applying deep learning techniques so as to mitigate imaging artifacts and improve image quality. The present disclosure provides an imaging acceleration method employing deep learning techniques to improve the image quality acquired with shortened acquisition time (i.e., fast scan). In some cases, the deep learning techniques may comprise using a convolutional neural network (CNN) to generate synthesized SPECT images from a fast scan with image quality comparable to SPECT images acquired with standard acquisition time (e.g., standard SPECT). This beneficially accelerates SPECT image acquisition by an acceleration factor of at least 1.5, 2, 3, 4, 5, 6, 7, 8, 9, 10, 15, 20, a factor of a value above 20 or below 1.5, or a value between any of the two aforementioned values. The provided method and systems can achieve a shortened acquisition time of no more than ½, ⅓, ¼, ⅕, ⅙, 1/7, ⅛, 1/9, 1/10 of the standard acquisition time.

The simultaneous SPECT and CT acquisition mode may facilitate the integration of input data from the two modalities. The CT images may provide complementary anatomical information depicting detailed high-resolution features that supplement the fast SPECT image. In some cases, the CT imaging may be performed at standard conditions (e.g., standard gantry rotation times, etc.) given that the CT scan duration is significantly shorter than the standard SPECT acquisition. Alternatively, CT acquisition may be accelerated by adopting an improved reconstruction algorithm.

### Methods and Deep Learning Framework

In an aspect of the present disclosure, the acceleration method herein may provide different models for synthesizing images based on a selected acceleration scheme. In some embodiments, an acceleration scheme may comprise one or more parameters related to a reduction of the acquisition time per acquisition plane (e.g., standard 10-40 s per acquisition plane), a reduction of the number of acquisition plane (e.g., standard 120 planes are acquired) or a combination of both. In some cases, SPECT may be 2.5 D imaging that two-dimensional (2D) slices are acquired at different planes (e.g., transaxial slices or axial slices, etc.) or may include different projections. A reduction of the number of acquisition planes or projections may introduce artifacts that is different from the artifacts introduced by shortening the acquisition time per plane. In some embodiments, different models may be selected based at least in part on an acceleration scheme or the types of artifacts.

In some cases, upon selection of an acceleration factor (e.g., acceleration factor of 20) or a target acquisition time, the methods and systems herein may automatically determine the one or more parameters for an acceleration scheme for achieving the acceleration factor or the target acquisition time. For example, upon receiving a target acceleration factor of 20, the system may automatically determine a reduction factor for the acquisition time per acquisition plane (e.g., reduction factor of 10 for acquisition time per acquisition plane) and a reduction factor for the number of acquisition plane (e.g., reduction factor of 2 for the number of acquisition plane). The acceleration scheme may be transmitted to the imaging apparatus to perform the accelerated imaging and the parameters of the acceleration scheme may also be used to determine the selection of the models for processing the fast SPECT image. In some cases, upon the acceleration scheme, denoising and super resolution method may also be applied at the projection level to further improve the image quality. Details about determining the acceleration scheme and/or parameters of an acceleration scheme are described later herein.

In some embodiments, upon determining an acceleration scheme (e.g., reduction factor for acquisition time per acquisition plane, reduction factor for reduction of the number of acquisition plane, etc.), systems and methods herein may select one or more trained models that adapt to the determined acceleration scheme and process images with the selected one or more trained model to improve the image quality.

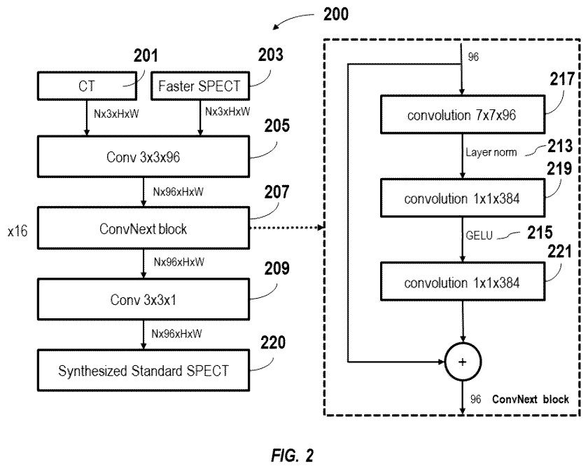

In some cases, a model may be selected from a plurality of trained models to process a fast SPECT image acquired by reducing acquisition time per acquisition plane. The model may be trained to synthesize SPECT image with improved quality (reducing artifacts) by taking a fast SPECT image acquired by reducing acquisition time per acquisition plane and a corresponding CT image as input. FIG. 2 shows an example of a deep learning framework 200 to synthesize SPECT image 220 from fast SPECT image 203 and the corresponding CT image 205. In some embodiments, the fast SPECT image 203 may be acquired by reducing acquisition time per acquisition plane. For example, the fast SPECT image may be acquired by reducing the standard acquisition time per acquisition plane (e.g., 10-40 seconds) by a factor of 2, 3, 4, 5, 6, 7, 8 or more.

As described above, shorten the acquisition time per acquisition plane leading to reduced/insufficient photon count (sensed by the imaging sensor) which may result in image artifacts. The deep learning framework 200 may be suitable (trained) for synthesizing a standard SPECT image from a fast SPECT image acquired by accelerating acquisition time per acquisition plane.

In some embodiments, the input fast SPECT image 203 may comprise one or more slices. For example, a sliding window of 3 slices (consecutive slices) across the SPECT image stack may be used to synthesize one output image, e.g., synthesized standard SPECT image 220. The sliding window can have any suitable size. For example, a series of 2, 3, 4, 5, 6, 7, 8, 9, 10 or more slices may be used to synthesize one standard SPECT image.

In some embodiments, the input data may comprise a pair of SPECT image 203 and CT image 201. In some cases, the input CT image 201 may have the same spatial resolution as the SPECT image 203. For instance, when the sliding window size is three, the input CT image 201 may have a dimension of N×3×H×W (i.e., 3 slices) with each slice corresponding to each slice of the input SPECT image 203 (e.g., N×3×H×W). An output of a SPECT/CT scan including the sliding window of the corresponding SPECT image and CT image may be used as the input to the deep learning model. The fast scan SPECT image and the CT image may be combined such as by registration of CT and SPECT images to bring these images into spatial alignment. After registration, fusion of SPECT and CT images may be performed to combine the functional information from SPECT with the anatomical information from CT.

The SPECT image and CT image may be acquired simultaneously. For example, the SPECT image and CT image may be acquired by a SPECT/CT scanner. The simultaneous SPECT and CT acquisition mode of the SPECT/CT scanner may facilitate the integration of input data from the two modalities. The CT images 201 may provide complementary anatomical information for depicting detailed high-resolution features that might be missed if only the fast SPECT images were used as input. The provided method may combine the fast scan SPECT image (e.g., fast SPECT image 203) and the corresponding CT image 201 as the input data. The fast scan SPECT image and the CT image may be concatenated and fed to a CNN.

For example, the input images may go through a single two-dimensional (2D) convolutional layer 205, a plurality of ConvNext blocks 207 and a final 2D convolutional layer 209. In some embodiments, the CNN architecture may comprise a plurality of ConvNext blocks 205. In the illustrated exemplary architecture, a ConvNext block 205 may use Gaussian Error Linear Unit (GELU) 215 as the activation function that is appended to the convolution layer. The ConvNext block 205 may have reduced number of activation functions with only one GELU between the two convolutional layer 219, 221. The ConvNext block 205 may comprise Layer Normalization (LN) 213 for normalization which has an improved performance than utilizing BatchNorm. The LN layer may be after a 7×7 depth-wise convolution 217 and the 1×1 convolutional layer 219. In some cases, the plurality of ConvNext block 205 may have identical architecture. Alternatively, the plurality of ConvNext block 205 may not have identical architecture.

The provided method may also utilize improved loss functions (e.g. loss function 111 in FIG. 1) to train the model. The loss function may be used to improve the accuracy and sharpness of the synthesized SPECT image and important region-of-interest (ROIs). In some embodiments, a combination loss function of structural similarity (SSIM) loss (L_{SSIM}) and L₁ loss is adopted. For example, to improve the accuracy and sharpness of the synthesized SPECT image and important regions of interest (ROIs), a loss function with combination of structural similarity (SSIM) loss L_{SSIM} and L₁ loss (i.e., L₁ norm loss) may be utilized. Below is an example of the loss function:

$$L = {L}_{1} + α {L}_{SSIM}$$

where α is a weight (e.g., α=0.5 or 1) that balances the SSIM loss and L₁ loss. In some cases, the two loss functions may be combined with an adjustable weight (e.g., α).

In some embodiments, attention loss (e.g., lesion attention loss) may be included to further enhance the accuracy in the lesion regions (e.g., SUV). For example, an attention mask loss may be added to highlight the importance of an ROI. Following is an example of the loss function which is minimized to train the CNN parameters:

$$loss = L + β L ⊙ M$$

where β is a weight (e.g., β=30, 100) that balances the lesion region loss and non-lesion region loss. The operator ⊙ represents the element wise multiplication. M represents the attention mask. The weight β may be adjustable to vary the amount of information in a ROI to be taken into account during training of the model

In some cases, an attention map or mask may be added to preserve information in a particular region. For example, a lesion attention mask may be included to highlight the loss in these regions. The attention map may comprise an attention feature map or ROI attention masks. The attention map may be a lesion attention map or other attention map that comprises clinically meaningful information. For example, the attention map may comprise information about regions where particular tissues/features are located.

An attention mask may be acquired automatically. In some cases, the attention mask may be generated from the same fast SPECT image without requiring additional scan or additional source of information. For example, the attention mask can be obtained based on a SUV threshold in the fast SPECT image. For instance, a SUV threshold may be selected and the fast SPECT image or input image may be filtered based on the threshold. In some cases, the filtered fast SPECT image may be used as the attention mask. The attention mask may need more accurate boundary enhancement compared to the normal structures and background. Including the attention mask may beneficially preserve the quantification accuracy and/or sharpness of the features (e.g., features of lesion, segment of bone lesion). The attention mask can be obtained using any other suitable methods such as utilizing deep learning techniques. Alternatively, the attention mask may be generated manually by manual selection/segmentation on an input image.

During a training stage, the training dataset may include the input data (including the combined fast scan SPECT and corresponding CT image) paired with the standard SPECT image as ground truth data. In some cases, the fast scan SPECT may be obtained by shortening the acquisition time per plane. In some cases, the ground truth data may be acquired by a SPECT scan with standard acquisition time per plane combined with the corresponding CT image i.e., standard SPECT/CT image acquired with the simultaneous SPECT and CT acquisition mode of the SPECT/CT scanner.

The training data may be obtained from an imaging system (e.g., SPECT/CT scanner, SPECT scanner, CT scanner), from external data sources (e.g., clinical database, etc.) or from simulated image sets. For example, the fast SPECT image may be simulated low-quality SPECT images that are generated by applying different levels or types of noise to the high-quality SPECT image (i.e., ground truth data). The term “high-quality” SPECT image may also be referred to as slow-scan SPECT image or standard SPECT image which are used interchangeably throughout the specification. The term “fast SPECT image” may also be referred to as low-quality SPECT image or accelerated SPECT image which are used interchangeably throughout the specification. Utilizing simulated low-quality SPECT images may beneficially augment the training dataset. Various data augmentation methods may be applied. For example, transformation may be applied to a fast SPECT image to rotate the image by a random degree (e.g., a random rotation centered on the center of a 3D scan), to scale the image by a random scale (e.g., random isotropic scaling in the range of [0.9, 1.0]) and/or mirror a scan (e.g., image is mirrored along a selected axis).

The image quality of the SPECT image as described herein may include general image quality, detail of radiotracer (e.g., 99mTc-MPD) distribution, presence of artifacts and/or general diagnostic confidence. In some cases, the low-quality SPECT image may be generated to simulate the artifacts caused by shortening the acquisition time per acquisition plane. In some cases, the low-quality SPECT image may be generated to simulate the artifacts caused by reducing the number of acquisition planes.

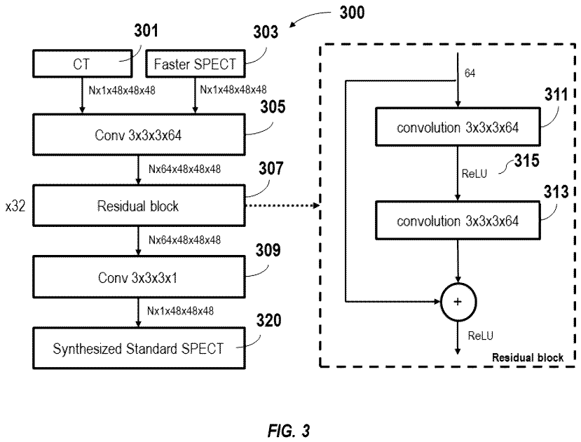

In some cases, a model may be selected that is suitable to process fast SPECT image acquired by reducing the number of acquisition planes. For instance, a model may be selected from plurality of trained models to synthesize SPECT image from a fast SPECT image acquired by reducing the number of acquisition planes and a corresponding CT image. FIG. 3 shows another example of a deep learning framework 300 to synthesize SPECT image 320 from fast SPECT image 303 and the corresponding CT image 305. In some embodiments, the fast SPECT image 303 may be acquired by reducing the number of acquisition planes. For example, the fast SPECT image may be acquired by reducing the number of acquisition planes (e.g., standard 120 planes) by a factor of 2, 3, 4, 5, 6, 7, 8 or more.

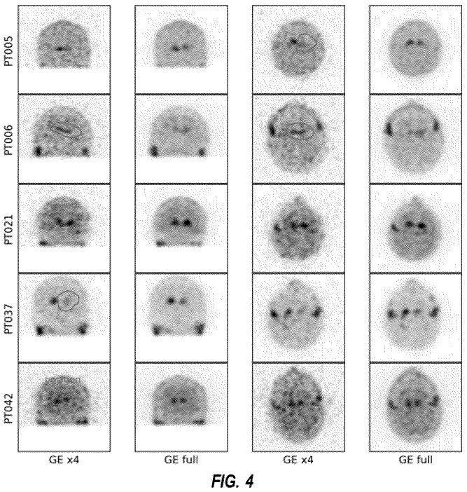

The reduction of the number of acquisition planes may lead to artifacts due to the missing information. In some cases, the types of artifacts caused by reducing a number of acquisition planes and by reducing an acquisition time per acquisition plane may be different. FIG. 4 shows examples of artifacts in fast SPECT acquired at an acceleration factor of 4. The examples illustrate the artifacts in the SPECT image acquired at 4 times faster. The acceleration is achieved by reducing the number of acquisition planes by a factor of 4 (e.g., number of acquisition planes is reduced to ¼ of the standard/full number).

In some cases, the reconstruction algorithm such as OSEM based reconstruction algorithms can be particularly sensitive to the decrease in the number of acquisition planes and may lead to artifacts in the images. For instance, OSEM based reconstruction algorithms may divide set of projections into subsets (or blocks). For example, if there were 64 projections (acquired at 64 angles about the patient), they may be divided as into 16 subsets, each containing 4 images (e.g., Subset 1: projections 1, 17, 33, 49, Subset 2: Projections 2, 18, 34, 50 . . . ). Each subset may contain projections equally distributed to help promote convergence of the algorithm. A maximum likelihood expectation maximization (MLEM) algorithm is then applied to each subset as a sub-iteration. The first full iteration is complete when all subsets have been processed. The number of subsets provides the approximate acceleration factor. When the number of projection planes decreases, the size of each subset is smaller and each subset contains less tomographic and statistical information. This can result in enhanced noise structures and other subset-related artifacts in the final image as illustrated in FIG. 4.

Methods herein may address the above artifacts (introduced by the reduction of number of acquisition planes) by including a greater context for the CNN. For instance, a 3D region (e.g., 3D region of 48³) may be extracted from the co-registered SPECT/CT images and fed to the CNN.

The input image to the deep learning network model may comprise co-registered 3D volume of the SPECT image and the CT image. Referring back to FIG. 3, the model 300 may process a 3D volume of co-registered SPECT/CT images (e.g., 3D region of 48³) 301, 303 as input. The input may comprise a block of voxels of CT (48³ voxels) 301 and faster SPECT (48³ voxels) 303. In some cases, each image block i may be normalized to have (0 mean, 1 standard_deviation) using (i−mean(i))/(standard_deviation(i)). The model may denoise the SPECT image block i with output o then the output o may be denormalized (e.g., using o*standard_deviation(i)+mean(i)).

In some embodiments, the CNN may comprise a 3D convolutional layer 305, a plurality of residual blocks 307 and a final 3D convolutional layer 309 to process the input image and generate a synthesized standard SPECT image 320.

In some embodiments, a residual block 307 may comprise a plurality of convolutional layers 311, 313 and a residual connection. In some cases, the outputs of an input convolutional layers 311 is followed by point-wise ReLU activation functions ReLU(⋅)=max(⋅, 0) 315.

The model 300 may be trained using any suitable algorithm. In some cases, L_{SSIM} and L₁ losses may be used to optimize the CNN parameters of the model 300. Any other suitable loss functions can be employed.

In some cases, the training dataset used for training the model 300 may comprise a combination of fast scan SPECT and corresponding CT image paired with the standard SPECT image as ground truth data. The fast scan SPECT image may be obtained by reducing the number of acquisition planes by various reduction factors. In some cases, the training data may comprise simulated image sets. For example, the fast acquisition of SPECT images may be simulated by refraining the sinogram and reconstructed using standard SPECT tools provided by the manufacturer of the SPECT. Various other data augmentation methods as described above can also be employed.

In some embodiments, methods and systems herein may further improve the quality of the image by denoising and/or increasing resolution of the image. In some cases, reconstructed images such as the fast SPECT image may be denoised in the image space prior to be processed by the CNN as described above for synthesizing standard SPECT image. However, when information is already lost (e.g., the acceleration is achieved by reducing number of projections/acquisition planes), the input reconstructed image for the denoising process may contain artifacts that can complicate the denoising task. The methods herein may apply denoising at the projection level prior to reconstruction. This may beneficially allow for leveraging information in the projections thereby improving the quality and robustness of the output. It should be noted that the denoising method applied at the projection level may be applied in combination with the denoising applied in the image space. Alternatively, the denoising method applied at the projection level may be provided as a standalone method in addition to or to replace the image space denoising method.

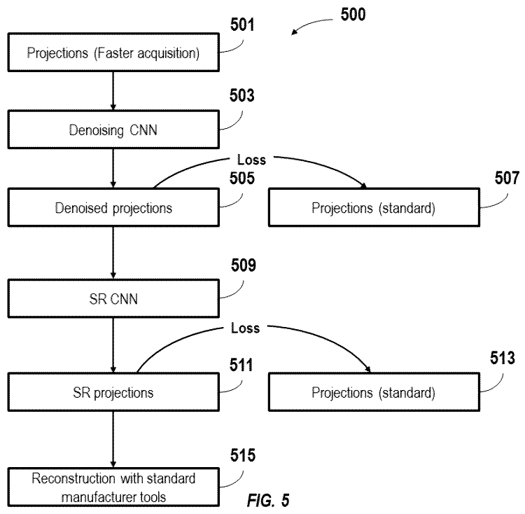

FIG. 5 shows an example of a method 500 for processing the raw acquisition data prior to reconstruction. In some embodiments, the method 500 may comprise both denoising for each projection and increasing resolution (e.g., super-resolution) of the data. In some cases, the raw acquisition data 501 may be obtained directly from the imaging device such as the SPECT/CT scanner (e.g., raw data include listmode files, attenuation maps, scanner calibrations, scatter and randoms estimates, etc.). The raw acquisition data 501 may comprise projections acquired by fast acquisition. For instance, the projections data may be obtained by shortening the acquisition time for a projection, reducing the number of projections or a combination of both.

In some embodiments, each projection may be denoised by leveraging information from the neighboring projections. For example, the method may comprise taking as input N (e.g., N=1, 2, 3, 4, 5, etc.) neighboring slices in each direction of the accelerated projection (e.g., accelerated per-projection acquisition time) and generate a denoised projection. As shown in FIG. 5, a denoising CNN 503 may take as input N neighboring slices (such as N=1, Projections 1, 2, 3 are the input to synthesize a denoised projection corresponding to Projection 2) and synthesize a denoised projection 506. The denoised projection 505 may be a projection acquired at standard acquisition time per projection (acquisition plane). In some cases, the denoising CNN 503 may be trained by minimizing a loss based at least in part on the standard Projections 507 (Projection data acquired at standard acquisition time per projection) and the synthesized denoised projection 505.

In some cases, the method may further comprise improving the resolution of the projection by creating projection planes. This may beneficially provide super resolution (SR) image. For example, missing projections may be re-created by interpolating neighboring projections. In some cases, one or more projections may be generated using a SR CNN.

In some cases, a SR CNN 509 may take M neighboring slices (M=1, 2, 3, 4, 5, etc.) as input to synthesize one or more projection planes. In some cases, the input to the SR CNN may further comprise information indicating a position of the projection plane to be synthesized. In some instances, the position of the projection plane may be represented by a value indicating a position of the projection plane to be synthesized relative to the M neighboring slices.

For example, in a SPECT apparatus, camera heads may be attached to a gantry, which rotates them around the patient and adjusts their distance relative to the center-of-rotation (COR). Projection images may be acquired as the gantry rotates the detectors in a continuous or step-and-shoot mode. For example, an SPECT image may be acquired using a dual-head gamma-camera with a 180° detector head orientation, rotating at a 360° circular orbit around a subject. The acquisition type may be a step-and-shoot mode where the camera acquires a projection, then stops recording data when moving to the next angle. For example, parameters for a step-and-shoot acquisition type may be 60-64 stops, a 128×128 matrix, and 10-40 seconds per stop. Alternatively, the SPECT projection images may be acquired using a continuous mode where the camera moves continuously and acquires each projection over an angular increment.

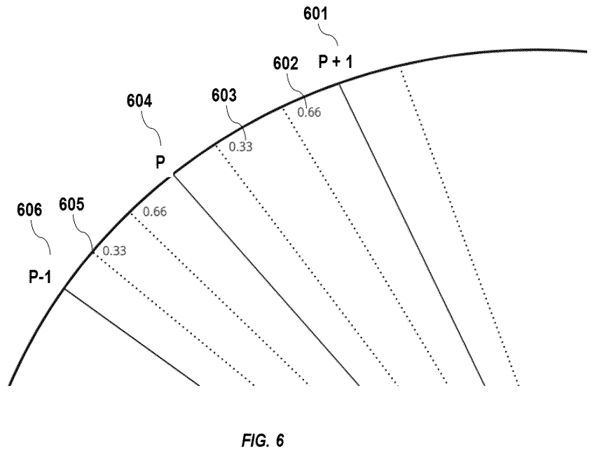

As shown in FIG. 6, a floating point value in the range of [0, 1] may correspond to a position of a target plane (plane to be synthesized) relative to two neighboring projection planes. For example, a position of target planes 602, 603 relative to the two neighboring planes 601, 604, may be represented by 0.33 and 0.66. Similarly, a position of a target plane 505 relative to the two neighboring planes 604, 606, may be represented by 0.33. It should be noted that any suitable numbers or representations can be utilized to indicate the location/position of the plane to be synthesized. The method herein may beneficially provide flexibility for selectively increasing a projection resolution. The above method may also be applied to increase the resolution for the 2.5D imaging.

Referring back to FIG. 5, the SR CNN 509 may take M neighboring slices (M=1, 2, 3, 4, 5, etc.) as well as a position of one or more target projections as input to synthesize the one or more projection planes 511. The SR CNN model 509 may be trained using any suitable algorithm. In some cases, the SR CNN model 509 may be trained by minimizing a loss based at least in part on the standard Projections 513 (Projections acquired at target position) and the synthesized projections 511. In some cases, the synthesized projections may be exported in a format based on the imaging device (e.g., DICOM image). In some cases, a standard manufacturer tool may be used to reconstruct the SPECT image 515. Any suitable reconstruction algorithm may be used to generate the output image. The output image may be the fast SPECT image which is processed by a selected model as shown in FIG. 2 or FIG. 3 to synthesize a standard SPECT image.

### System Overview

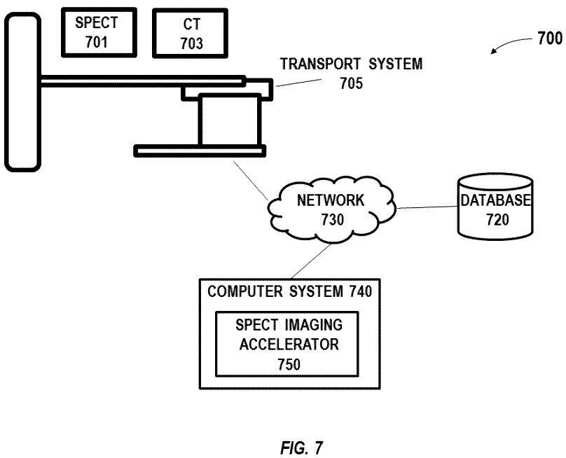

The systems and methods can be implemented on existing imaging systems such as but not limited to SPECT imaging system, CT imaging system or SPECT/CT imaging systems without a need of a change of hardware infrastructure. FIG. 7 schematically illustrates an example of a system 700 comprising a computer system 740 and one or more databases operably coupled to an imaging system over the network 730. The computer system 710 may be used for further implementing the methods and systems explained above to improve the quality of images.

As described above, a SPECT-CT imaging system combines single photon emission computed tomography (SPECT) gamma cameras and computed tomography (CT) into one imaging system. Alternatively, the imaging system may comprise separate SPECT imaging system and CT system where the SPECT and CT images are processed and combined to generate an input data. In some embodiments, the SPECT/CT imaging system may comprise a controller for controlling the operation, imaging of the two modalities (SPECT imaging module 701, CT imaging module 703) or movement of transport system 705. For example, the controller may control a CT scan based on one or more acquisition parameters set up for the CT scan and control the SPECT scan based on one or more acquisition parameters set up for the SPECT scan. The SPECT imaging module 301 may be performed by using a gamma camera to acquire multiple 2-D images (i.e., projections), from multiple angles. The controller may apply a tomographic reconstruction algorithm (e.g., filter backprojection (FBP), iterative algorithm such as algebraic reconstruction technique (ART), etc.) to the multiple projections, yielding a 3-D data set. The SPECT image may be combined with the CT image to generate the combined image as output of the imaging system. For example, reconstruction algorithms have been developed in bone hybrid imaging (SPECT/CT) scanner. Different from classic SPECT reconstructions, such reconstruction algorithms may utilize an ordered subset conjugate gradient minimization algorithm (OSCGM) for image reconstruction. This construction algorithm can provide SPECT images with bone anatomy appearance as a CT-based tissue segmentation is incorporated into SPECT reconstruction and also provide a quantitative reconstruction. Such progress of image acquisition and reconstruction could convey a higher diagnostic confidence through an enhanced bone uptake location. Other reconstruction algorithms as described above may also be employed to generate the reconstructed image.

The controller may be coupled to an operator console (not shown) which can include input devices (e.g., keyboard) and control panel and a display. For example, the controller may have input/output ports connected to a display, keyboard and or other IO devices. In some cases, the operator console may communicate through the network with a computer system that enables an operator to control the production and display of images on a screen of display. For example, images may be images with improved quality and/or accuracy acquired according to an accelerated acquisition scheme. For example, a user may set up the scan time, an acceleration factor and the like for acquiring the accelerated SPECT image and/or a standard SPECT image.

The system 700 may comprise a user interface. The user interface may be configured to receive user input and output information to a user. The user input may be related to controlling or setting up an image acquisition scheme. For example, the user input may indicate scan duration (e.g., the min/bed) for each acquisition or scan time for a frame that determines one or more acquisition parameters for an accelerated acquisition scheme. In some cases, upon selection of an acceleration factor (e.g., acceleration factor of 20) or a target acquisition time, the SPECT imaging accelerator 750 may automatically determine the one or more parameters for an acceleration scheme for achieving the acceleration factor or the target acquisition time. For example, upon receiving a target acceleration factor of 20, the SPECT imaging accelerator 750 may automatically determine a reduction factor for the acquisition time per acquisition plane (e.g., reduction factor of 10 for acquisition time per acquisition plane) and a reduction factor for the number of acquisition plane (e.g., reduction factor of 2 for the number of acquisition plane). Details about determining the acceleration scheme and/or parameters of an acceleration scheme are described later herein. The user input may be related to the operation of the SPECT/CT system (e.g., certain threshold settings for controlling program execution, image reconstruction algorithms, etc). The user interface may include a screen such as a touch screen and any other user interactive external device such as handheld controller, mouse, joystick, keyboard, trackball, touchpad, button, verbal commands, gesture-recognition, attitude sensor, thermal sensor, touch-capacitive sensors, foot switch, or any other device.

The system 700 may comprise computer systems and database systems 720, which may interact with a SPECT imaging accelerator 750. The computer system may comprise a laptop computer, a desktop computer, a central server, distributed computing system, etc. The processor may be a hardware processor such as a central processing unit (CPU), a graphic processing unit (GPU), a general-purpose processing unit, which can be a single core or multi core processor, or a plurality of processors for parallel processing. The processor can be any suitable integrated circuits, such as computing platforms or microprocessors, logic devices and the like. Although the disclosure is described with reference to a processor, other types of integrated circuits and logic devices are also applicable. The processors or machines may not be limited by the data operation capabilities. The processors or machines may perform 512 bit, 256 bit, 128 bit, 64 bit, 32 bit, or 16 bit data operations. The imaging platform may comprise one or more databases. The one or more databases may utilize any suitable database techniques. For instance, structured query language (SQL) or “NoSQL” database may be utilized for storing image data, raw collected data, reconstructed image data, training datasets, trained model (e.g., hyper parameters), loss function, weighting coefficients, etc. Some of the databases may be implemented using various standard data-structures, such as an array, hash, (linked) list, struct, structured text file (e.g., XML), table, JSON, NOSQL and/or the like. Such data-structures may be stored in memory and/or in (structured) files. In another alternative, an object-oriented database may be used. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present disclosure is implemented as a data-structure, the use of the database of the present disclosure may be integrated into another component such as the component of the present disclosure. Also, the database may be implemented as a mix of data structures, objects, and relational structures. Databases may be consolidated and/or distributed in variations through standard data processing techniques. Portions of databases, e.g., tables, may be exported and/or imported and thus decentralized and/or integrated.

The network 730 may establish connections among the components in the imaging platform and a connection of the imaging system to external systems. The network may comprise any combination of local area and/or wide area networks using both wireless and/or wired communication systems. For example, the network may include the Internet, as well as mobile telephone networks. In one embodiment, the network uses standard communications technologies and/or protocols. Hence, the network may include links using technologies such as Ethernet, 802.11, worldwide interoperability for microwave access (WiMAX), 2G/3G/4G/5G mobile communications protocols, asynchronous transfer mode (ATM), InfiniBand, PCI Express Advanced Switching, etc. Other networking protocols used on the network can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), and the like. The data exchanged over the network can be represented using technologies and/or formats including image data in binary form (e.g., Portable Networks Graphics (PNG)), the hypertext markup language (HTML), the extensible markup language (XML), etc. In addition, all or some of links can be encrypted using conventional encryption technologies such as secure sockets layers (SSL), transport layer security (TLS), Internet Protocol security (IPsec), etc. In another embodiment, the entities on the network can use custom and/or dedicated data communications technologies instead of, or in addition to, the ones described above.

In some embodiments, the SPECT imaging accelerator 750 may comprise multiple components, including but not limited to, a training module, an image enhancement module, an acceleration scheme generator and a user interface module.

The training module may be configured to train a model using the deep learning model framework as described above. The training module may train the model to predict a SPECT image with quality improved over the input low-quality SPECT. The training module may be configured to obtain and manage training datasets. For example, the training datasets for may comprise pairs of standard acquisition and shortened acquisition SPECT images, CT images and/or attention feature map from the same subject. The training module may be configured to train a deep learning network for enhancing the image quality as described elsewhere herein. The training module may be configured to implement the deep learning methods as described elsewhere herein. The training module may train a model off-line. Alternatively or additionally, the training module may use real-time data as feedback to refine the model for improvement or continual training.

The image enhancement module may be configured to enhance the SPECT image quality using a trained model obtained from the training module. The image enhancement module may implement the trained model for making inferences, i.e., outputting SPECT images with quality improved over the input fast scan SPECT image.

The user interface (UI) module may be configured to provide a UI to receive user input related to the ROI and/or user preferred output result. For instance, a user may be permitted to, via the UI, set acceleration parameters (e.g., acquisition time) or identify regions of interest (ROI) in the lower quality images to be enhanced. The UI may display the improved SPECT image.

Methods and systems of the present disclosure can be implemented by way of one or more algorithms. An algorithm can be implemented by way of software upon execution by the central processing unit.

### Acceleration Scheme

In some embodiments, an acceleration scheme may comprise reduction of the acquisition time per acquisition plane (e.g., 10-40 s per acquisition plane), reduction of the number of acquisition plane (e.g., standard 120 planes) or a combination of both. In some cases, upon selection of an acceleration factor (e.g., acceleration factor of 20) or a target acquisition time, the methods and systems herein such as the acceleration generator may automatically determine an acceleration scheme for achieving the acceleration factor or the target acquisition time. In some embodiments, upon determining an acceleration scheme (e.g., reduction factor for acquisition time per acquisition plane, reduction factor for reduction of the number of acquisition plane, etc.), systems and methods herein may select models that adapt to the determined acceleration scheme and process images with the selected model to improve the image quality. For instance, the acceleration scheme may be transmitted to the imaging apparatus to acquire the fast SPECT image and the parameters of the acceleration scheme may be used to determine the selection of the models for processing the acquired fast SPECT image.

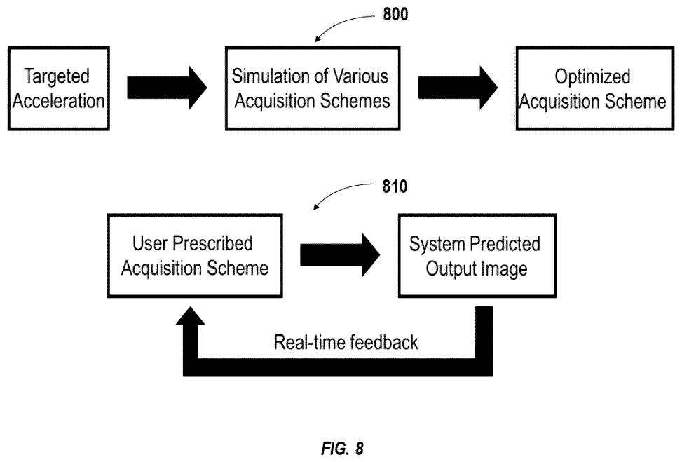

FIG. 8 shows examples of determining an acquisition scheme via the aforementioned acceleration scheme generator. An acquisition scheme may be determined autonomously, semi-autonomously or manually. In a fully automated mode 800, the imaging accelerator may be configured to automatically determine an optimal acquisition scheme. For example, a user may input, via a user interface, a target acceleration. The target acceleration may be provided via any suitable formats on the aforementioned GUI, such as a selection from drop-down menu, manipulating a graphical element (e.g., slider bar), direct input in a text box (e.g., input an acceleration factor) or via other suitable means such as voice command and the like. The acceleration may be related to an aspect of image acquisition, including but not limited to, acceleration factor, acquisition speed, image resolution, field of view, and target region. In an example, the target acceleration may be a selection from ‘fast acquisition’, ‘mid acquisition’, ‘slow acquisition.’ In another example, the target acceleration may be an acceleration factor such as a factor of 1.5, 2, 3, 4, 5, 10, 15, 16, 17, 18, 19, 20, a factor of a value above 20 or below 1.5, or a value between any two of the aforementioned values.

In some cases, an acquisition scheme may comprise a reduction factor for the acquisition time per acquisition plane (e.g., reduction factor of 4 for acquisition time per acquisition plane) and/or a reduction factor for the number of acquisition plane (e.g., reduction factor of 2 for the number of acquisition plane). The optimal acquisition scheme may be determined based on empirical data.

In some embodiments, in response to receiving the target acceleration, a simulation of one or more acquisition schemes may be performed in order to determine an optimal acquisition scheme. In some cases, the one or more acquisition schemes may be applied to image patches to increase computation speed in the simulation. The optimal acquisition scheme may be determined based on a predetermined rule. For instance, the optimal acquisition scheme may be determined based on the quality of the output image (patch). For example, an acquisition scheme meeting the target acceleration goal while providing the best quality images may be selected. In some cases, the determined acquisition scheme may be displayed to a user for further approval or further adjustment. The approved or determined acquisition scheme may be transmitted to the controller of the SPECT/CT system for controlling the imaging operation of the imaging system consistent with the disclosure herein.

In some case, a user may be allowed to define an acquisition scheme in a semi-autonomous fashion 810. A user may specify one or more parameters of an acquisition scheme. In response to receiving the acquisition scheme, the system may run simulations and output images associated with the acquisition scheme. A user may or may not further adjust the acquisition scheme so as to change the quality or other characteristics of the output images. In some instances, a user may be provided with system advised adjustment. In some instances, a user may manually adjust one or more parameters upon viewing the simulated output images on a display. In some cases, the simulated image may be dynamically updated while the user adjusting one or more parameters of the acquisition scheme. The determined acquisition scheme may then be transmitted to the controller of the SPECT/CT system for controlling the operations of the imaging system as described elsewhere herein.

In some embodiments, the acquired accelerated image may be processed to synthesize a standard image as described above. In some cases, the system may determine which model to be used for processing the image based at least in part on the acceleration scheme. For example, if the acceleration is achieved by reducing the acquisition time per acquisition plane (e.g., the acceleration parameter is acquisition time per plane is reduced by a factor of X), a CNN model as described in FIG. 2 may be utilized and if the acceleration is achieved by reducing the number of acquisition planes (e.g., the acceleration parameter is the number of acquisition plane is reduced by factor of X), a CNN model as described in FIG. 3 may be selected. In some cases, when the acceleration is achieved by a combination of accelerating the acquisition time per plane and reducing the number of projections, the image may be processed by both types of models.

In some cases, the model selection may be based at least in part on the reduction factor or the dominant artifacts. For instance, when the acceleration scheme includes a first parameter indicating that acquisition time per plane is accelerated by a factor of 2 and a second parameter indicating the number of acquisition planes is reduced by a factor of 4, the system may determine that the dominant artifacts is introduced by the second parameter and a model corresponding to the reduction of acquisition plane (e.g., model in FIG. 3) may be selected. Alternatively, the system may select a model corresponding to the reduction of acquisition time per plane (e.g., model in FIG. 2) while the missing projections may be interpolated using the method described above. In another example, when the acceleration scheme includes a first parameter indicating that acquisition time per plane is accelerated by a factor of 7 and a second parameter indicating the number of acquisition planes is reduced by a factor of 2, the system may determine that the dominant artifacts is introduced by the first parameter and a model corresponding to the reduction of acquisition time per plane (e.g., model in FIG. 2) may be selected. It should be noted that the processes, methods, and models can be applied in any combination and/or in any suitable order to achieve a final improved image quality.

### Experiments and Results

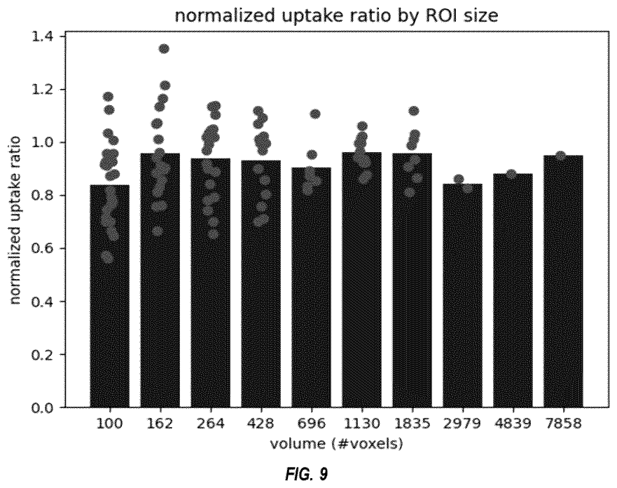

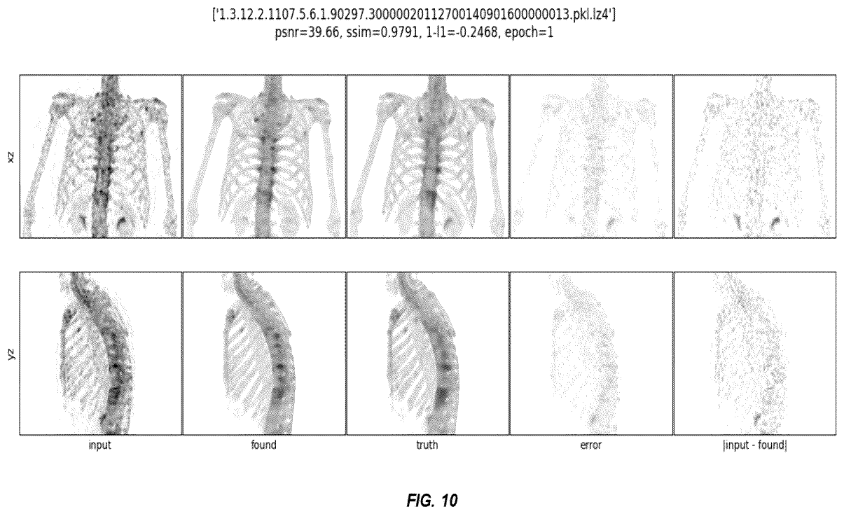

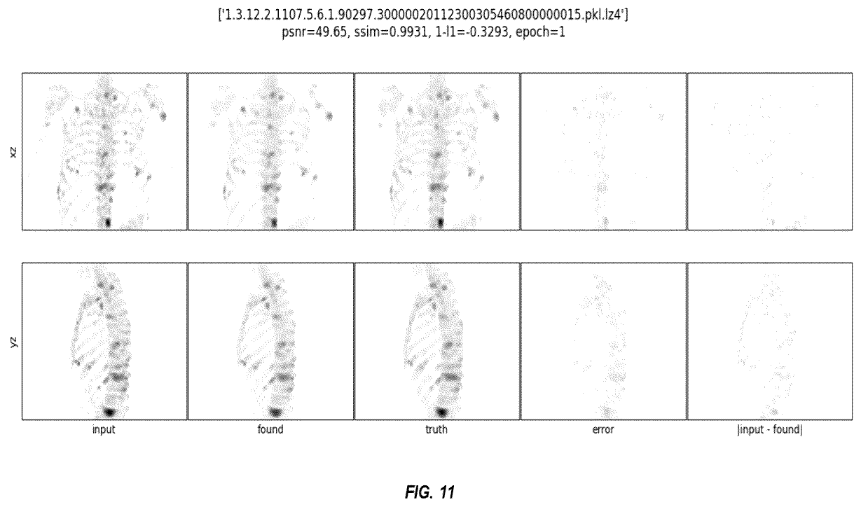

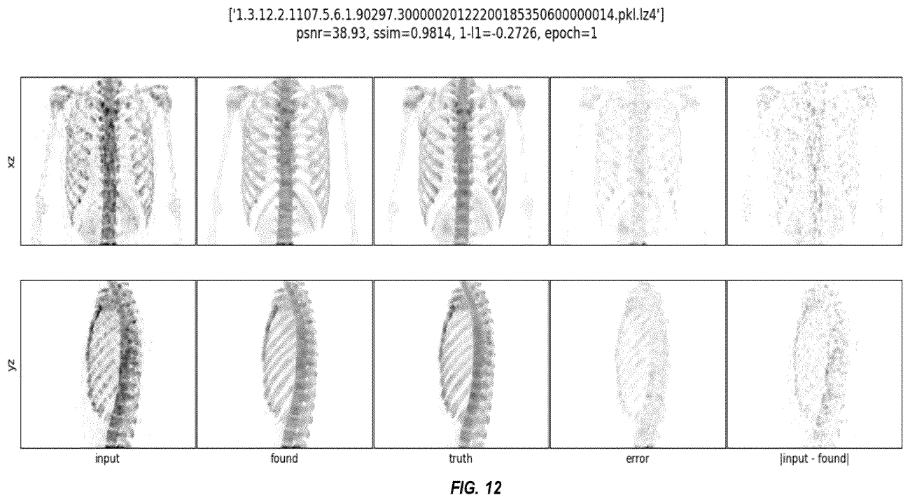

FIGS. 9-12 show results from an experiment implementing the provided methods and systems. In particular, the experiment implements the model described with respect to FIG. 2 which is suitable for acceleration of acquisition time per projection/plane. In the example, 34 Patients were injected with 99mTC and acquired 4 h post-injection using Symbia Intevo 16 for 20 min and a parallel hole collimator. Acquisition was subsequently repeated by reducing the time to 1/7th of the time (3 min). The data was acquired using a 128×128 matrix using 120 projections (60 per camera head) covering an arc of 360 degrees. The images were reconstructed using xSPECT Bone (ordered subset conjugate gradient minimization algorithm) using 2 subsets and 24 iterations, a 7.5 mm gaussian FWHM post-filter was applied. 10 patients were selected for training (5 with bone lesions and 5 without any lesions) and the remaining 24 were used for the validation of the method. The model was trained for 8000 epochs. For each patient, 2 sub-volume of 256×256×3 voxels were randomly drawn to constitute a batch of 6 samples. The model was optimized using AdamW optimizer.

The L₁, SSIM and average quantification ratio (AQR) are reported. AQR is calculated for each segmentation S in M such that AQR=Mean_{S}(faster SPECT)/Mean_{S}(standard SPECT) were AQR=1.0 means the average count in the faster SPECT image in a segmentation is identical to the standard SPECT.

As shown in the following table and results in FIGS. 9-12, the PSNR, SSIM and L1 show the CNN can accurately recover from the noisy faster SPECT and match the characteristics of the standard SPECT image. The synthesized images are of improved quality and no false positive or false negative lesions were observed.

| metric | current |
|---|---|
| PSNR | 41.700 |
| SSIM | 0.981 |
| L1 | 0.293 |
| Wholebody reconstruction | 11.584 (s) |
| time | |
| AQR | 0.899 |

### Experiment 2

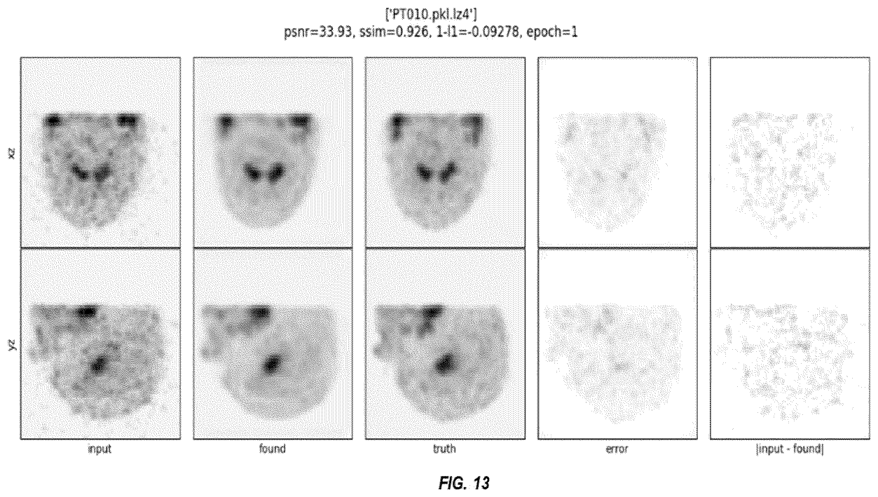

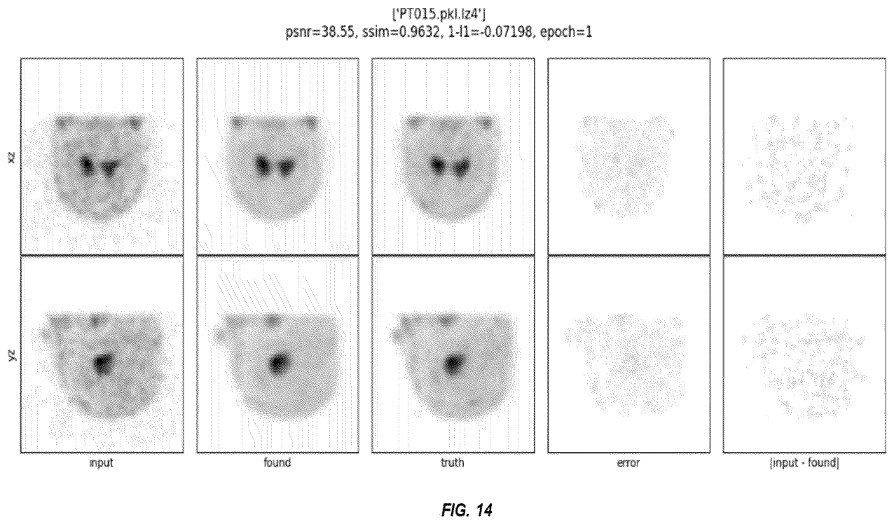

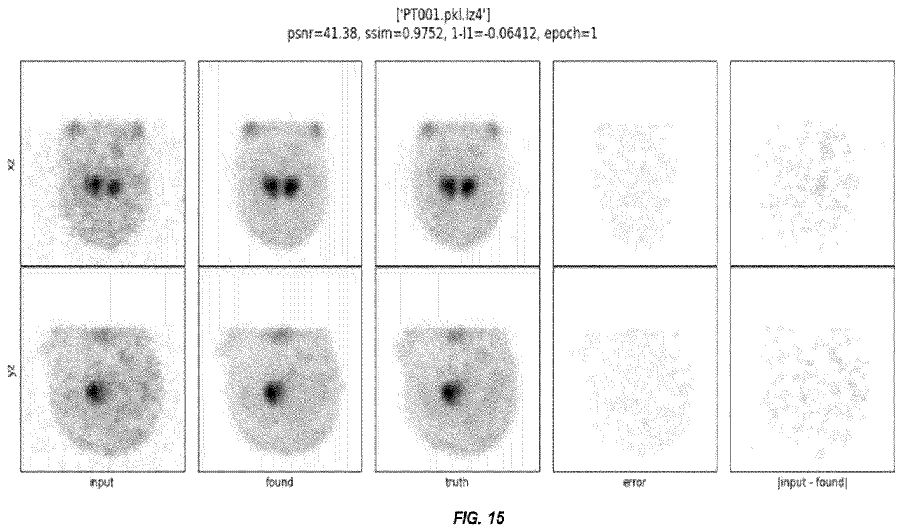

FIGS. 13-15 show results from an experiment implementing the model described with respect to FIG. 3 which is suitable for reducing the number of projections/planes. DaTscans were acquired on a GE Optima 640 Dual Head SPECT scanner with an LEHR collimator for 120 projections (60 projections on each head) at 30 increments. The raw sinogram was retrospectively undersampled to create sinograms with 30 projections (4× faster). The projection data were then reconstructed using OSEM (2 iterations, 10 subsets) to generate 4× input SPECT images. The model was trained for 2000 epochs. The batch size was 12 samples. The model was optimized using AdamW optimizer.

The results are demonstrated in FIGS. 13-15 (e.g., examples of ×4 enhanced faster DaTscans) and the following table. The denoising preserves the shape and activity in striatal structures and are clinically equivalent to the Standard DaTscans.

| metric | current |
|---|---|
| PSNR | 35.50 |
| SSIM | 0.945 |
| L1 | 0.077 |
| Reconstruction time | 1.2 (s) |

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A computer-implemented method for improving image quality comprising:
(a) receiving a first medical image of a subject, wherein the first medical image is acquired with an acceleration scheme using single-photon emission computed tomography (SPECT);
(b) combining the medical image with a second medical image acquired using computed tomography (CT) to generate an input image; and
(c) applying a deep learning network model to the input image and outputting an enhanced medical image, wherein the deep learning network model is selected based at least in part on the acceleration scheme.

2. The computer-implemented method of claim 1, wherein the enhanced medical image has an image quality same as a SPECT image acquired with an acquisition time longer than the acquisition time of the acceleration scheme or has an image quality improved over the first medical image.

3. The computer-implemented method of claim 1, wherein the acceleration scheme comprises at least a first parameter indicating a shortened acquisition time per acquisition plane or a second parameter indicating a reduction of the number of acquisition planes.

4. The computer-implemented method of claim 1, wherein the acceleration scheme comprises a first parameter indicating a shortened acquisition time per acquisition plane, and wherein the deep learning network model is trained using training dataset comprising a SPECT image acquired with shortened acquisition time per acquisition plane, a corresponding CT image and a SPECT image acquired using a standard acquisition time acquisition plane.

5. The computer-implemented method of claim 4, wherein the input image to the deep learning network model comprises a plurality of image slices and wherein the deep learning network model comprises a 2D convolutional layer.

6. The computer-implemented method of claim 4, wherein the deep learning network model is trained using a loss function to enhance an accuracy in a region of interest.

7. The computer-implemented method of claim 4, wherein the deep learning network model is trained using an attention mask.

8. The computer-implemented method of claim 1, wherein the acceleration scheme comprises a second parameter indicative of a reduction of the number of acquisition planes, and wherein the deep learning network model is trained using training dataset comprising a SPECT image acquired with a reduction of acquisition planes, a corresponding CT image and a SPECT image acquired using a standard number of acquisition planes.

9. The computer-implemented method of claim 8, wherein the input image to the deep learning network model comprises co-registered 3D volume of the first medical image and the second medical image.

10. The computer-implemented method of claim 9, wherein the deep learning network model comprises a 3D convolutional layer.

11. The computer-implemented method of claim 1, wherein the deep learning network model is selected from a plurality of trained models, and wherein the plurality of trained models correspond to different types of artifacts or different acceleration schemes.

12. The computer-implemented method of claim 1, wherein the first medical image is processed by a convolutional neural network (CNN) to synthesize one or more projection planes prior to operation (c).

13. The computer-implemented method of claim 1, wherein the first medical image and the second medical image are acquired simultaneously.

14. The computer-implemented method of claim 13, wherein the second medical image is acquired without acceleration.

15. A non-transitory computer-readable storage medium including instructions that, when executed by one or more processors, cause the one or more processors to perform operations comprising:
(a) receiving a first medical image of a subject, wherein the first medical image is acquired with an acceleration scheme using single-photon emission computed tomography (SPECT);
(b) combining the medical image with a second medical image acquired using computed tomography (CT) to generate an input image; and
(c) applying a deep learning network model to the input image and outputting an enhanced medical image, wherein the deep learning network model is selected based at least in part on the acceleration scheme.

16. The non-transitory computer-readable storage medium of claim 15, wherein the enhanced medical image has an image quality same as a SPECT image acquired with an acquisition time longer than the acquisition time of the acceleration scheme or has an image quality improved over the first medical image.

17. The non-transitory computer-readable storage medium of claim 16, wherein the acceleration scheme comprises at least a first parameter indicating a shortened acquisition time per acquisition plane or a second parameter indicating a reduction of the number of acquisition planes.

18. The non-transitory computer-readable storage medium of claim 15, wherein the acceleration scheme comprises a first parameter indicating a shortened acquisition time per acquisition plane, and wherein the deep learning network model is trained using training dataset comprising a SPECT image acquired with shortened acquisition time per acquisition plane, a corresponding CT image and a SPECT image acquired using a standard acquisition time acquisition plane.

19. The non-transitory computer-readable storage medium of claim 18, wherein the input image to the deep learning network model comprises a plurality of image slices and wherein the deep learning network model comprises a 2D convolutional layer.

20. The non-transitory computer-readable storage medium of claim 18, wherein the deep learning network model is trained using a loss function to enhance an accuracy in a region of interest.
